(19) United States
(12) Patent Application Publication
(10) Pub. No.: US 2014/0033987 A1
(43) Pub. Date: Feb. 6, 2014

(54) MODULAR ANIMAL EXERCISE STRUCTURE

(71) Applicant: Solv It Products, LP, (US)

(72) Inventors: Patrick Hoffman, Arlington, TX (US); David King, Allen, TX (US); Thomas B. Murphy, Arlington, TX (US)

(73) Assignee: SOLV IT PRODUCTS, LP, Arlington, TX (US)

(21) Appl. No.: 13/752,118

(22) Filed: Jan. 28, 2013

Related U.S. Application Data
(60) Provisional application No. 61/591,485, filed on Jan. 27, 2012.

(51) Int. Cl. A01K 15/02

(52) U.S. Cl. CPC A01K 15/02
USPC 119/706

(57) ABSTRACT

A modular play structure for animals has base and platform pieces with connector mechanisms, such countersunk bores, spaced apart by a standard distance. Thus platforms and bases can be oriented in multiple directions and are interchangeable. Columns space the bases and platforms vertically. Columns may be of varying height, preferably with different heights described by a common factor. Stacked columns are connected end-to-end with a spacer of the same thickness as a platform interposed therebetween. Columns are oriented in the same direction with female and male ends connecting with platform, base, and adjacent columns.

### CROSS-REFERENCE TO RELATED APPLICATIONS

This is a Non-Provisional utility application claiming priority to U.S. Provisional Application Ser. No. 61/591485, filed Jan. 27, 2012.

### TECHNICAL FIELD

The invention concerns a modular animal exercise and play structure, and more particularly a structure designed for ease of set-up, variety of potential arrangements of modules, and interchangeability of modules.

### BACKGROUND OF INVENTION

It is well known that animals, especially cats, enjoy climbing, jumping, perching on tall objects, investigating enclosed spaces, and scratching to exercise and sharpen claws. To this end, products have been developed that facilitate these needs and behavior for domestic pets. The products currently available for use as play structures have limitations that effect utility. Some products require extension of the structure from floor to ceiling for the structure to be adequately supported. Other products take up an inordinate amount of space. Further, many products available for use as play structures have a substantially fixed configuration and are not meant to be modified once installed. Where structures are able to be modified, a few parts are repositionable within the framework of the existing structure. Other structures are difficult to store, assemble and disassemble. Some structures are covered with carpet-like material, which is insufficiently resistant to the clawing action of a cat. It is an object of the invention to overcome these limitations.

### SUMMARY OF THE INVENTION

The inventions disclosed herein are directed to a modular play structure for animals, particularly for cats. Base and platform pieces have connector mechanisms, such as bores, spaced apart by a standard distance. Any three adjacent connectors, therefore, define an equilateral triangle. Thus platforms and bases can be oriented in more than one direction, and platforms and bases are interchangeable when assembling or re-assembling the structure. Columns are provided for spacing the bases and platforms vertically. The columns may be of varying height, preferably with different heights being described by a common numerical factor. In one embodiment, stacked columns are connected end-to-end with a spacer interposed therebetween. The spacer is of the same thickness as a platform such that a column-spacer-column arrangement is the same height as a column-platform-column arrangement. The columns are oriented in the same direction, for example, with female ends down and male ends up. The female and male ends cooperate with the platform and base connector mechanisms. Further, the female ends connect to the male ends of adjacent (stacked) columns. In a preferred embodiment, the male end of a column includes an extending male threaded post which cooperates with a female threaded aperture defined in the female end of another column. In a preferred embodiment, the female threaded aperture is defined in a protrusion or boss extending from the end of the column. The boss then cooperates with the connector bores in the platforms and bases. End caps are provided for connecting a column end to a platform or base where an additional column is not stacked above.

### DESCRIPTION OF THE DRAWINGS

Drawings of a preferred embodiment of the invention are annexed hereto, so that the invention may be better and more fully understood, in which numeral references are employed to designate like parts throughout the various figures of the drawing, and in which:

FIG. 1 is an elevational exploded view of an exemplary column for use in an exercise structure according to an aspect of the invention.

FIG. 2 is an exploded assembly view of two columns and intervening spacer according to an aspect of the invention.

FIGS. 3A-B are orthogonal and side views of an exemplary spacer piece for use in an embodiment of the invention.

FIGS. 4A-B are elevational views of showing comparative lengths of longer and shorter column members, including spacers, according to an aspect of the invention.

FIGS. 5-7 are orthogonal views of exemplary modular structures in various arrangements according to an aspect of the invention.

FIGS. 8-10 are orthogonal assembly views of a wrapped column according to an aspect of the invention according to an aspect of the invention.

FIGS. 11-12 are schematic views of exemplary base members indicating spacing of connector holes according to an aspect of the invention.

FIGS. 13-14 are orthogonal views of exemplary modular structures having multiple base members in various arrangements according to an aspect of the invention.

FIG. 15 is a detail view of an accessory for attachment to a structure according to an aspect of the invention.

FIG. 16 is an orthogonal view of an exemplary modular structure having the accessory of FIG. 15 according to an aspect of the invention.

FIG. 17 is a schematic exploded view in partial cross-section of a bottom end cap for use in an embodiment of the invention.

FIG. 18 is a schematic exploded view in partial cross-section of a top end cap for use in an embodiment of the invention.

FIG. 19 is a top schematic view, shown in overlay, of multiple platforms 60 and a base piece 70 in an exemplary arrangement according to an aspect of the invention

### DESCRIPTION OF PREFERRED EMBODIMENTS OF THE INVENTION

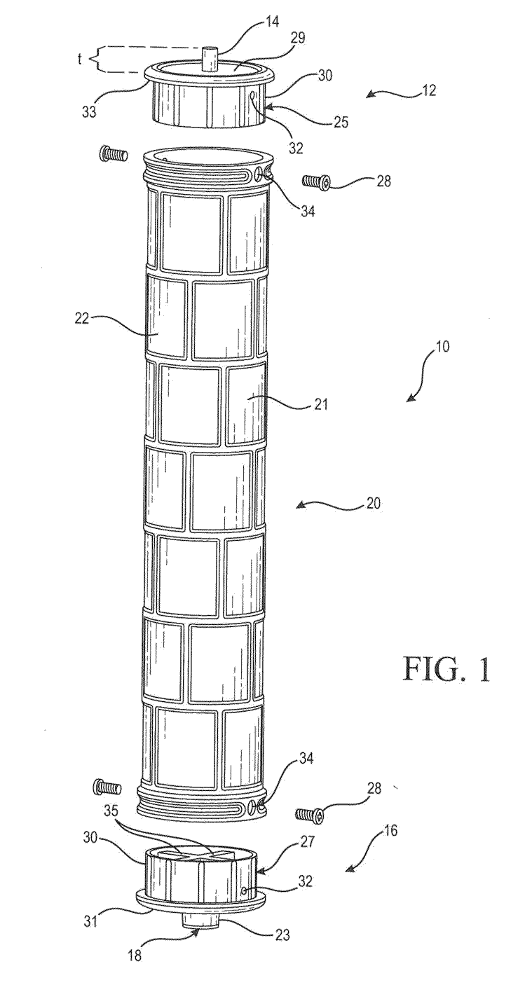

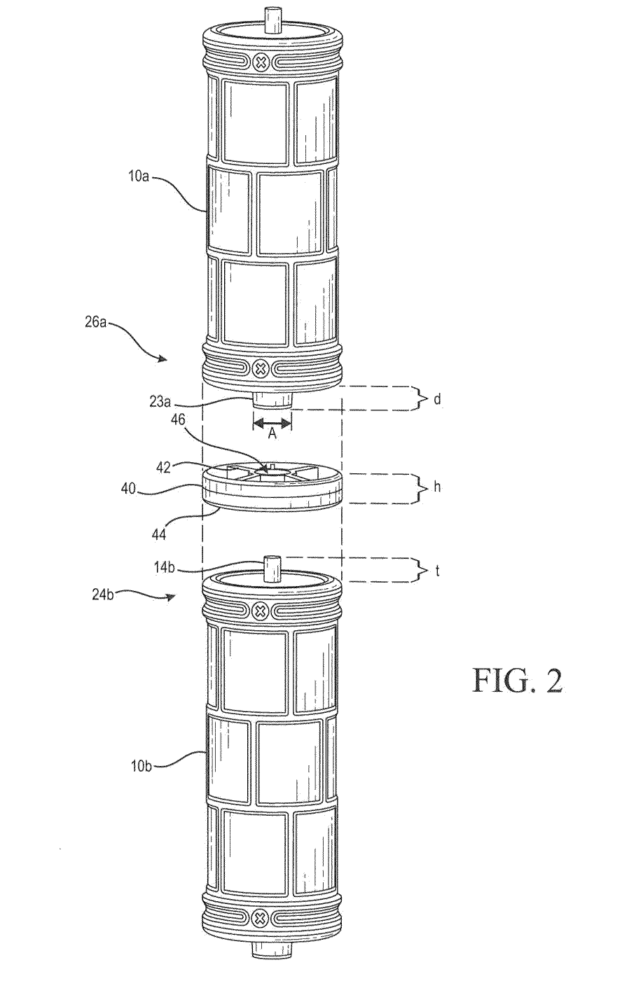

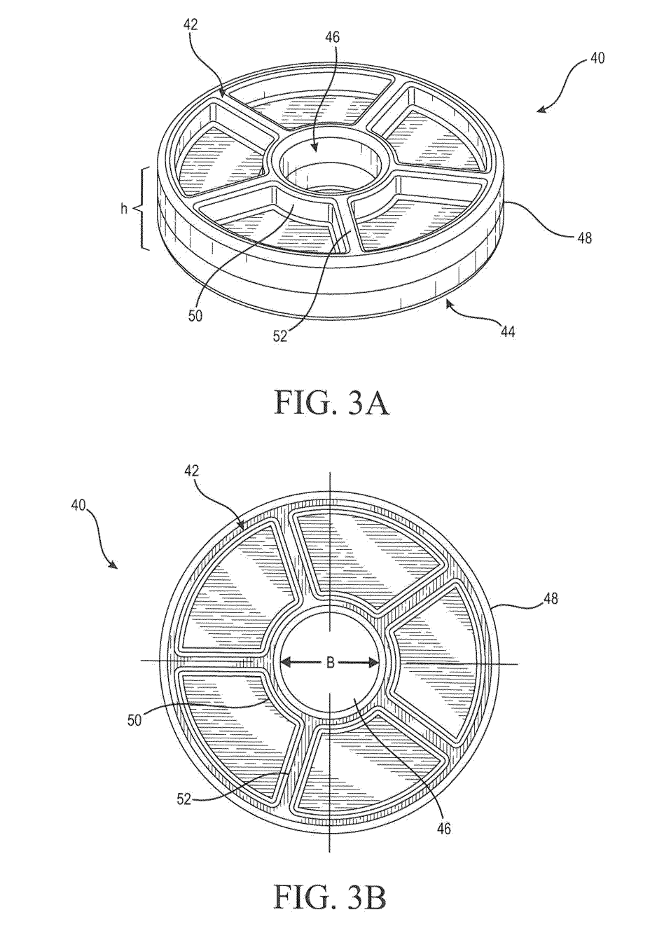

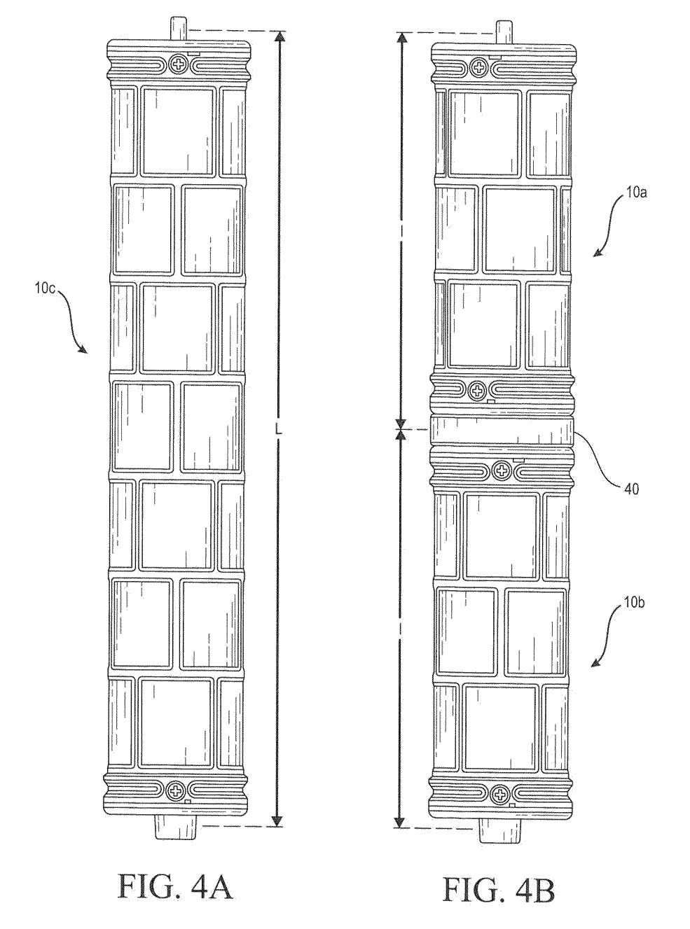

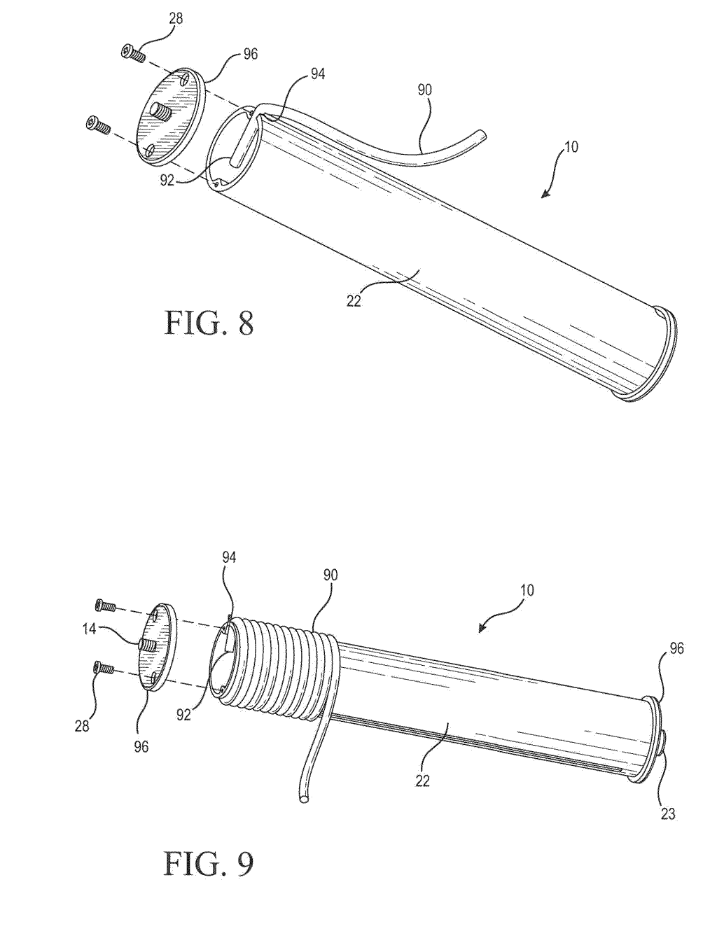

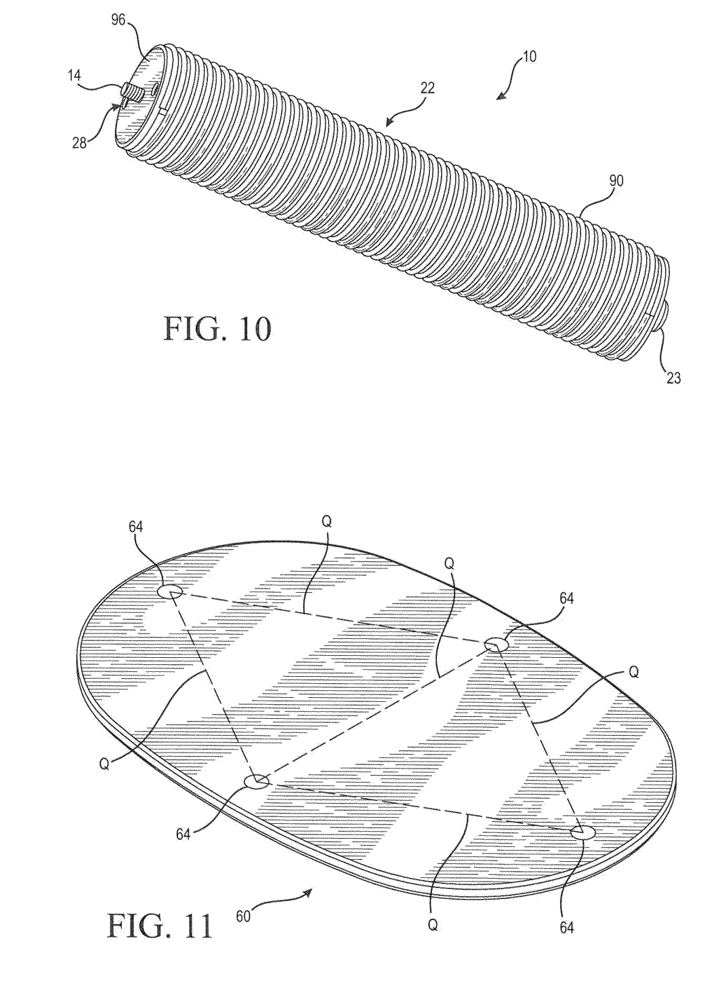

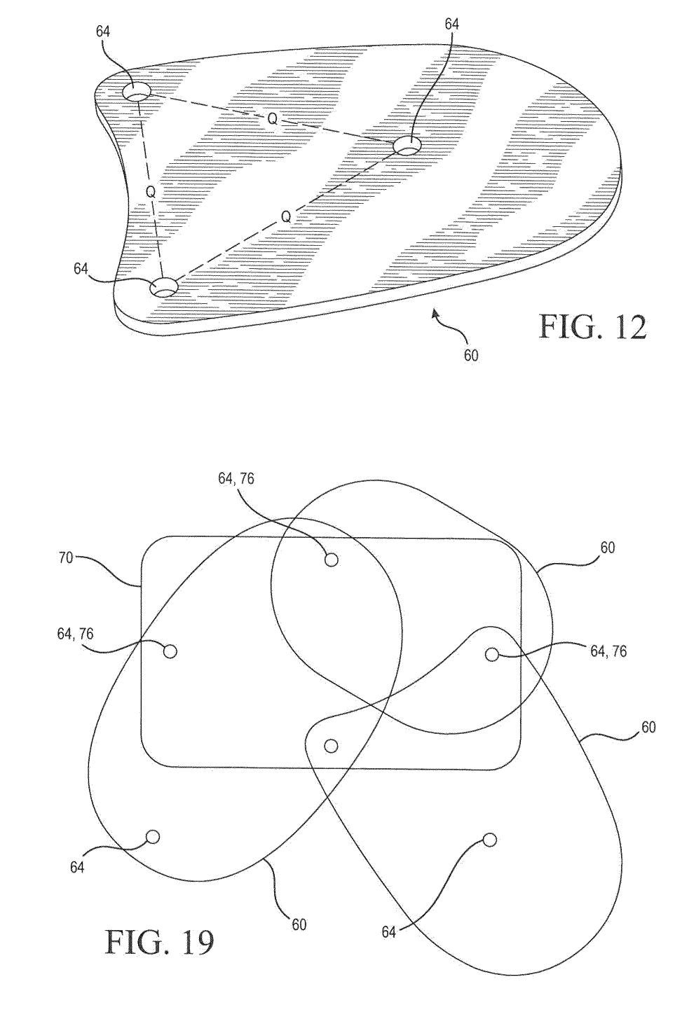

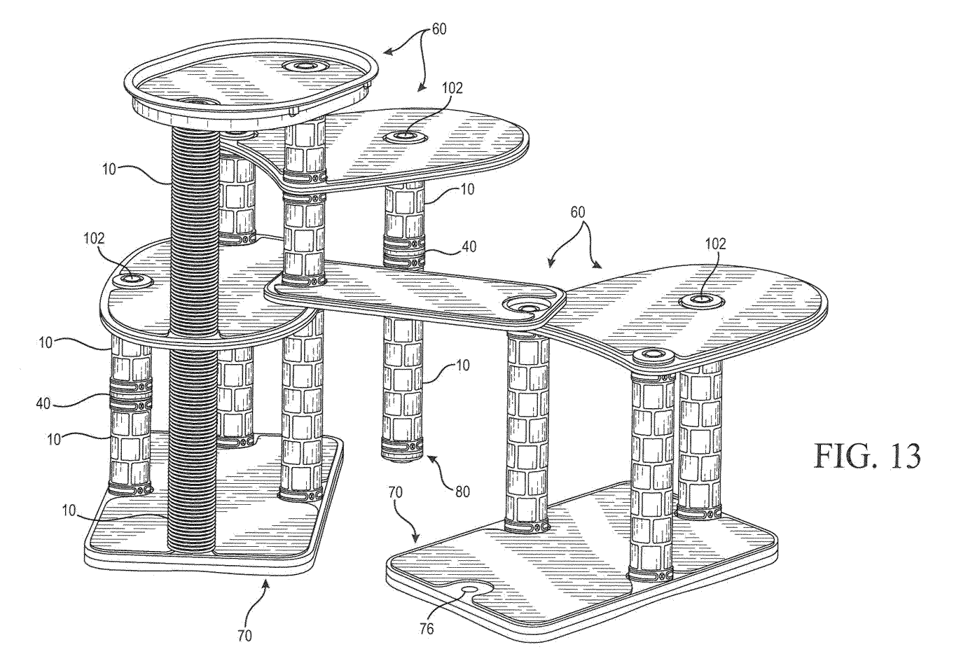

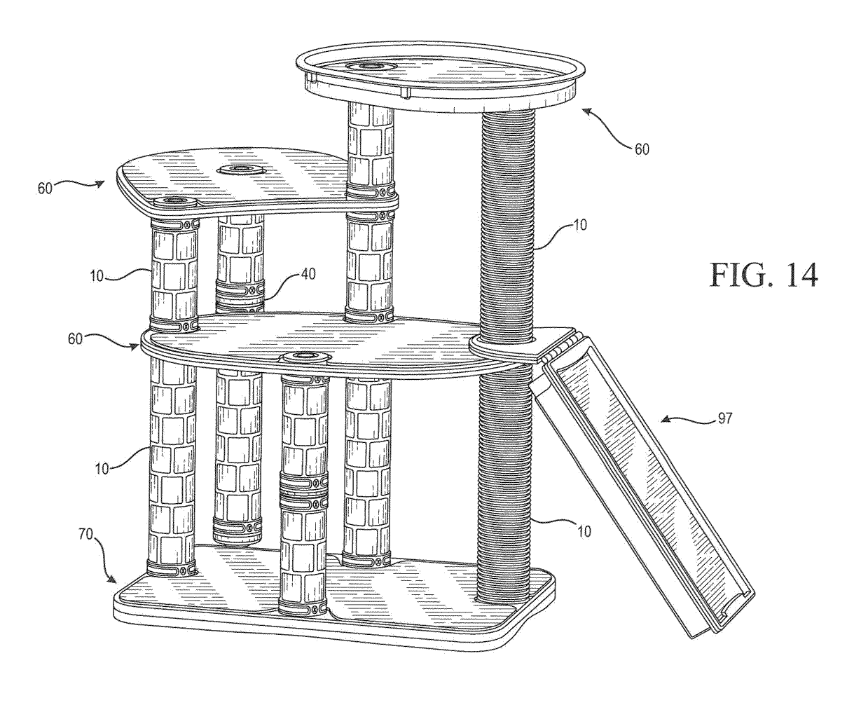

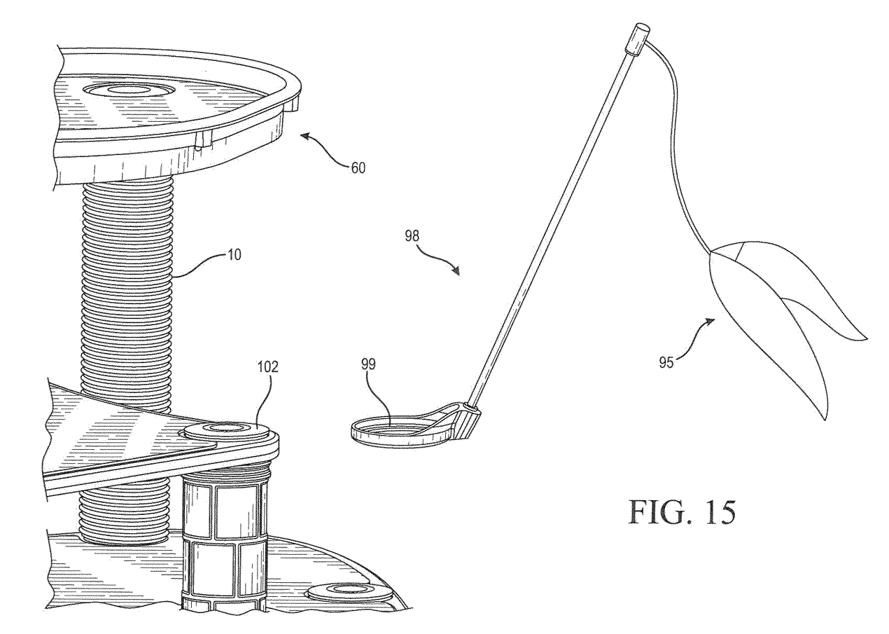

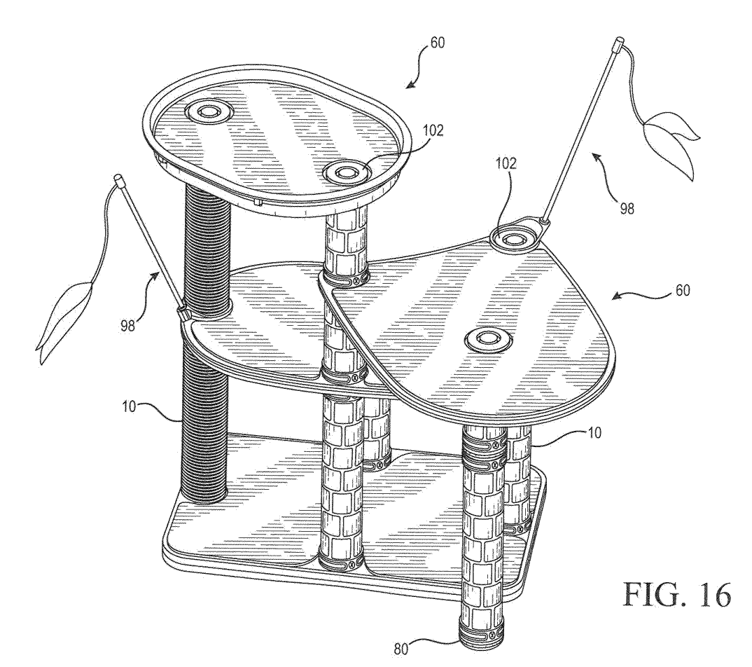

For disclosure regarding modular play structures for animals, see U.S. Pat. No. 5,577,466 to Luxford, filed Sep. 7, 1994, which is hereby incorporated herein for all purposes. FIG. 1 is an elevational exploded view of an exemplary column for use in an exercise structure according to an aspect of the invention. FIG. 2 is an exploded assembly view of two columns and intervening spacer according to an aspect of the invention. FIG. 3 is an assembled view of the columns and spacer of FIG. 2. FIGS. 4A-B are elevational views of showing comparative lengths of longer and shorter column members, including spacers, according to an aspect of the invention. FIGS. 5-7 are orthogonal views of exemplary modular structures in various arrangements according to an aspect of the invention. FIGS. 8-10 are orthogonal assembly views of a wrapped column according to an aspect of the invention according to an aspect of the invention. FIGS. 11-12 are schematic views of exemplary base members indicating spacing of connector holes according to an aspect of the invention. FIGS. 13-14 are orthogonal views of exemplary modular structures having multiple base members in various arrangements according to an aspect of the invention. FIG. 15 is a detail view of an accessory for attachment to a structure according to an aspect of the invention. FIG. 16 is an orthogonal view of an exemplary modular structure having the accessory of FIG. 15 according to an aspect of the invention.

Each column 10 has a male end 12, preferably having a male threaded post 14 extending axially therefrom. Each column has a female end 16, preferably having a female threaded socket 18 defined in the female end of the column and for receiving a male end of other structure pieces, such as the male end of an adjoining column. In the preferred embodiment, adjoining columns are threadedly connectable to one another. The threaded post extends a distance, t, from the end of the column and cooperates with a threaded female socket defined in an adjacent column.

FIG. 1 shows a preferred construction of an exemplary column. The column 10 is comprised of a cylindrical member 20 defining a wall 21 and an exterior surface 22. The column ends 12 and 16 are preferably defined by end members 25 and 27, respectively, which are attached to the cylindrical member 20 by multiple fasteners 28, shown as screws. Alternately the end members can be adhered, melted, welded, sonic welded, or fastened with any number of rivets, ties, clips, etc., as is known in the art, or the ends can be formed integrally with the cylindrical member. The end members can also connect to the cylindrical member by friction fit, snap ring, cooperating resilient members and recesses, etc., as is known in the art. The cylindrical member is preferably hollow to reduce weight and expense. Preferably each end member 25 and 27 defines a column end surface 29 and 31, respectively, and a cylindrical flange 30, which fits into and cooperates with an open end of the cylindrical member. Note that the open ends of the cylindrical member 20 can be reinforced, such as with a thickened or contoured lip portion 33, as shown. Further, the end members can have stiffening elements 35, shown as multiple spoke walls extending radially across the cap and contacting the flange at either end. The flanges have fastener holes 32 through which the fasteners 28 extend. The flange fastener holes 32 align with corresponding cylindrical member fastener holes 34 and the fasteners 28 extend through corresponding holes, thereby securing the end members to the cylindrical member.

In a preferred embodiment, the male end member 25 has an attached male threaded post 14 extending axially therefrom, preferably perpendicular to the end surface 29. The female end member has an axially extending female threaded socket 18 defined therein. In the embodiment shown, the female socket 18 is defined in a thickened portion of the end member defined by a cylindrical protrusion or boss 23. The protrusion 23 is generally cylindrical, defines a female threaded socket therein, extends generally perpendicularly from the end surface 31 of the cylindrical member, has a diameter less than the diameter of the cylindrical member 20, and protrudes a distance, d, from the end surface 31. As explained herein, preferably the distance, d, is the same as the height, h, of the spacer piece 40.

Turning now to FIGS. 2-4, in an embodiment, the columns are intended to be connected to one another with a “spacer” piece 40 interposed between them. The spacer 40 is seen in aligned orientation between an upper column 10a and a lower column 10b in FIG. 2. The upper column 10a has its female end 26a adjacent the upper surface 42 of the spacer while the lower column 10b has its male end 24b adjacent a lower surface 44 of the spacer. The spacer has a height, h, and a diameter, the diameter preferably equal to that of the upper and lower columns. Defined in the spacer 40 is a bore 46 extending axially therethrough and of a size to cooperate with the protrusion 23a extending from the lower surface of the upper column 10a. The protrusion can provide a friction fit with the bore 46. However, where manufacturing methods create significant variability of dimensions, for example, with injection molding, it may be desirable to design a greater clearance distance between parts to insure a correct fit. The upper and lower surfaces 42 and 44 are designed and can be contoured to fit snugly against the adjacent column end surfaces. In such an embodiment, the threaded post 14b of lower column 10b is screwed into connection with the female socket 18a defined in protrusion 23a of upper column 10a until the upper and lower surfaces of the spacer abut the corresponding end surfaces of the upper and lower columns. In one embodiment, the spacer height, h, the protrusion distance, d, and the threaded post length, t, are substantially equal. However, equivalence is not necessary for adequate performance. As an example, the threaded post height, t, can be less that the protrusion distance, d, as long as the post extends through the space and into the female socket of the protrusion sufficiently to connect the columns. Further, in one embodiment, the spacer height, h, is slightly greater than the protrusion distance, d, such that upon assembly the spacer is slightly compressed, such as between upper and lower column ends. The compression of the spacer acts to reduce the occurrence of unwanted back-out of the threaded post in a manner similar to a spring-washer.

FIG. 3A is an orthogonal view of an exemplary spacer piece for use in an embodiment of the invention. FIG. 3B is the spacer of FIG. 3A seen in an elevational view. The exemplary spacer 40 is made of plastic, has a diameter equal to that of the columns, and a height h selected to cooperate with the male and female connectors protruding from the ends of the columns between which the spacer is disposed. The size, shape, contours, etc., of the spacer are selected to provide a stable and snug fit between column and spacer. The spacer 40, in one embodiment, has upper and lower faces, 42 and 44 respectively, defined by the uppermost and lowermost extents of the spacer. An outer ring 48 is joined to an inner ring 50 by a plurality of spokes 52. The inner ring defines the bore 46 extending through the spacer. The bore cooperates with a protrusion 23 at one end of a column 10 and preferably has a bore diameter, B, substantially the same as the protrusion diameter, A. Additional embodiments will be apparent to those of skill in the art, such as providing additional or fewer spokes, web surfaces between spokes, using a solid disk to connect inner and outer rings, using a disk in lieu of the ring and spoke construction, etc.

For example, in an alternate embodiment, the spacer can define a thread on the wall of the bore 46 to cooperate with a corresponding thread defined on the exterior wall of the protrusion 23. Further, the spacer can carry connector mechanisms (threaded post and female socket, snap-tight connectors, etc.) such that the spacer connects directly to the upper and lower columns. In an embodiment of the invention which does not employ a protrusion 23 to house the female socket, the bore 46 of the spacer can be of smaller diameter to accept the threaded post 14 therethrough, and can be threaded or smooth.

FIGS. 4A-B are provided to illustrate the relative effective lengths of various columns for use in combination in the structure. The columns are provided in multiple lengths (or heights), such that some columns are shorter and others taller (or longer). The columns 10 are provided in different effective lengths (or heights), preferably a “longer” column 10c, of effective length L, and a “shorter” column 10a, of effective length 1, where effective length L is a factor of effective length 1. Additional lengths of column can be provided, where the lengths of longer columns are factors (of 2, or 3, or 4, etc.) of the shortest column. When discussing the “effective length” of the columns, note that this is the additional overall length added to connected members. The effective length of a column is the length of the cylindrical member plus half the protrusion distance, d, plus half of the threaded post height, t. Half of the protrusion and post lengths are used in calculating effective length since, after connection, the protrusion of one column overlaps the post of an adjacent column. In the embodiment shown, the effective length of the shorter columns, 1, is half the effective length, L, of the longer column 10c. The spacer 40 between columns 10a and 10b does not “add” to the overall length of connected columns in the preferred embodiment. Thus, multiple shorter columns 10a-b can be joined together, with spacer(s) 40 interposed between them, to achieve an equivalent total effective length to a corresponding longer column 10c. It is therefore possible to mix-and-match columns of varying length to achieve different play structure configurations to meet the individual needs of the consumer.

As seen in FIGS. 5-7, adjoining columns are also intended to be connected to platform pieces 60, which can be interposed between connected columns and serve as “spacers.” The columns are also designed to be connected to a base piece 70 or a foot piece 80. For example, a column can be connected to a base piece using a bottom end cap 102, as explained herein. A column can be connected to an outrigger foot piece, with a spacer interposed therebetween, as discussed herein.

In FIGS. 5-7, base pieces 70 provide stable platforms for the assembled structure 100 and contact the floor and with one or more columns 10 extending upwardly therefrom. The illustrated base 70 is substantially rectangular, and has rounded corners to prevent damage or injury. The base can take other shapes as well, such as triangular, circular, organic, etc. Preferably, the base piece 70 is of a relatively larger size, for example, having four or more holes. Where the base piece is designed to be of a thickness equivalent to that of a platform, the base piece can also be used as a suspended platform supported by columns. However, such an arrangement is not preferred since the base is preferably heavier and footed to provide a stable platform for the structure. A base piece can have as many columns extending upwardly therefrom as it has holes or connector mechanisms. Alternately, a base platform can have fewer columns extending therefrom than it has holes. In such an instance, a top end cap and bottom end cap can be connected through the base connector hole such that no open holes are left in the assembled structure. A column can extend from the base piece and simply terminate at its upper end (for example, as a scratching post). Further, one or more columns can extend from the base piece to support suspended platforms above.

The base piece height, b, is preferably equivalent to the spacer height h, plus a foot height (where the foot height is preferably equivalent to the spacer height). Stated another way, the base height is approximately twice a spacer height. The base can be made of any material, which can be selected, for example, for the weight, stiffness, or levelness it provides to increase stability of the assembled structure. A cover layer 72 can be applied to the upper surface 74 of the base piece 70 if desired, such as carpet, cork board, etc. The base piece 70 has a plurality of connector holes 76 defined therein. The base connector holes 76 have a diameter, C, substantially the same as the protrusion diameter, A, for accepting the protrusion 23. In one embodiment, the base connector holes 76 can be countersunk from below, such that the countersink diameter cooperates with the bottom end cap diameter.

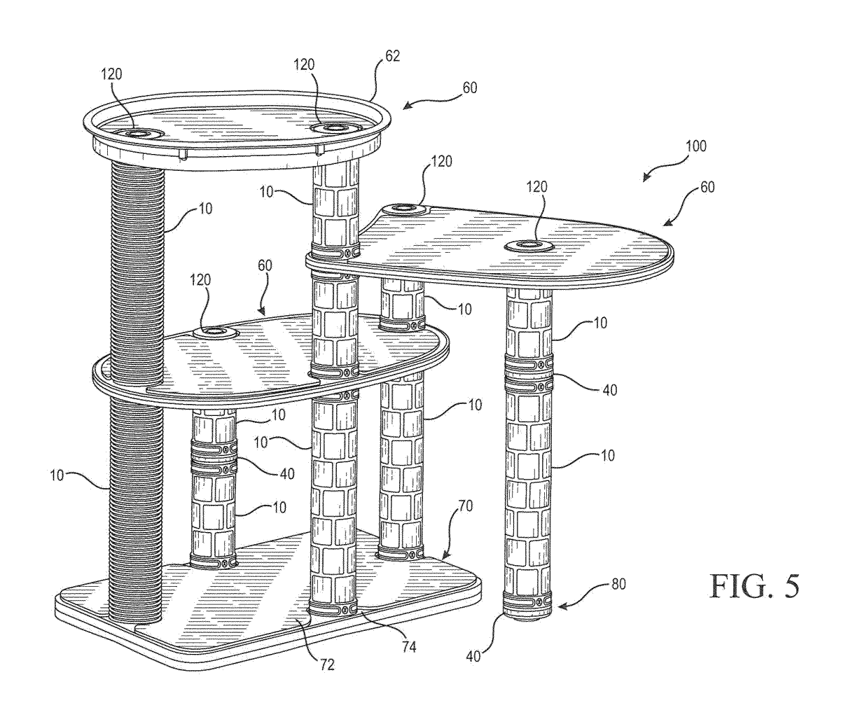

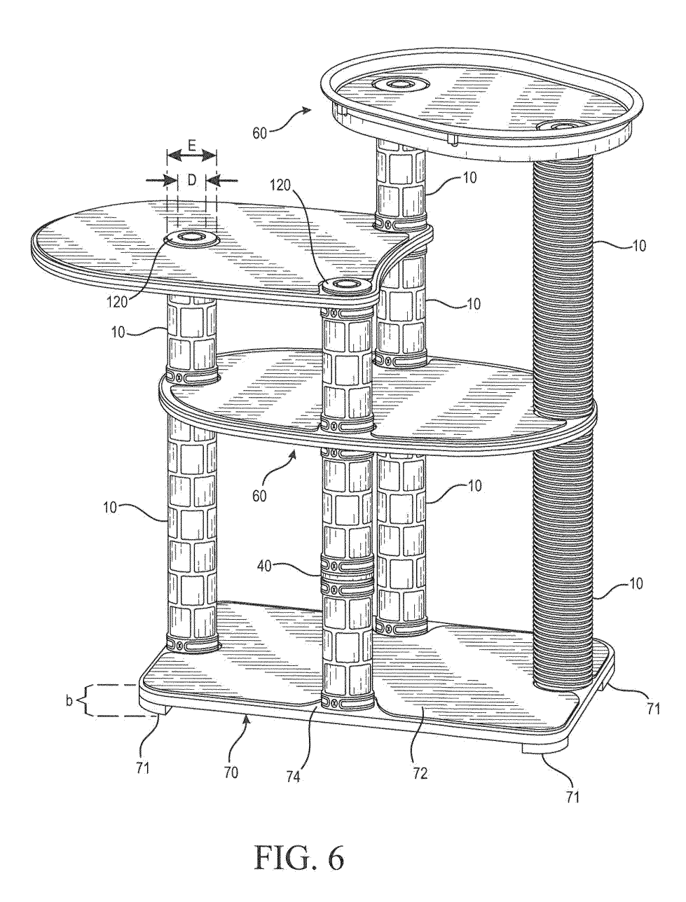

Preferably, the base piece 70 has feet 71 extending downwardly from the base piece. Exemplary feet 71 are visible in FIG. 6. In such a case, the feet 71 have a height which preferably corresponds to a projection height, f, of bottom end caps 102 as explained elsewhere herein. In one embodiment, the height of the feet 71, bottom cap projection, and spacer are all equivalent. The feet 71 provide stability to the base, especially where the base piece itself tends to warp or be uneven. Additionally, the feet provide ballast, again for stability, and can be made of heavier material for this purpose. Where the base piece is sufficiently flat and even, feet are less preferred. Adjustable feet can be used, as are known in the art.

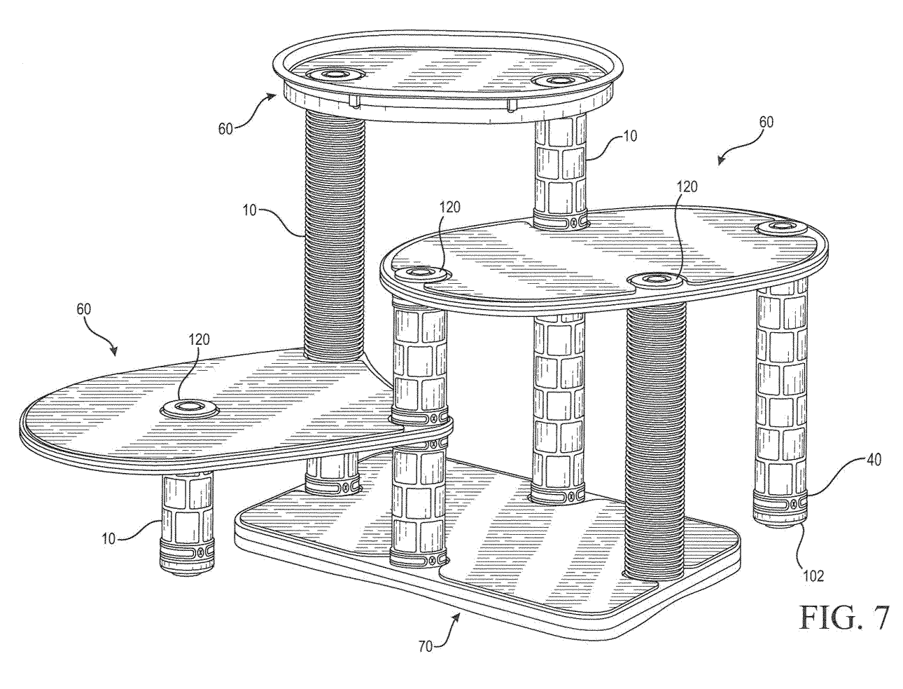

Also seen in FIGS. 5 and 7 are foot pieces 80. These will not be described in detail as, in one embodiment, they are similar to base pieces but of a particular size and shape, namely cylindrical. The foot pieces 80 are preferably circular and of a diameter equivalent to that of a column, as shown. The foot pieces are preferably of a height equivalent to that of a base piece. The foot pieces 80 allow a column, or stacked columns, to stand directly on the floor (rather than on a base piece), as seen in FIGS. 5, 7 and 13-15. In another embodiment, the foot pieces are used in conjunction with a spacer at the lower end of a column. In such an arrangement, a spacer piece is interposed between a column end and the foot piece. The foot piece is similar to the bottom end caps described herein, and so will not be discussed in detail, and has a threaded post for connection to the column protrusion and an effective height equivalent to a base foot, spacer, or other corresponding element.

The platform pieces 60 can take various shape and size, as shown. Preferably, each platform extends between and is connected to at least two columns for stability. The platforms can extend across two, three or more columns, as shown, or more. It is preferred, but not necessary, that each of the connector holes of a platform be used in connection with a cooperating column. The platform pieces can be of various shape, such as circular, ovoid, rectangular, organic, etc. Further, a platform piece can have a rim 62 defined at its perimeter, if desired. Further, the platform pieces can have cut-outs (not shown) for accepting food and water dishes, toy holders, or for allowing pet access through the platform. Each platform has a platform height, p, which is the same as the spacer height, h. In this manner, platforms and spacers are interchangeable and either can be interposed between and connected to adjacent columns while maintaining the appropriate spacing and dimensions of the columns. Platforms can be supported by multiple columns, columns supported in turn by other columns or base piece(s), or by column(s) supported by a foot piece. Platforms can “bridge” from a portion of the structure supported by a first base piece to another portion of the structure supported by another base piece, as seen in FIG. 13.

The platforms define connector mechanisms 64, preferably holes or bores, for connecting the platform to one or more adjacent columns or to a top cap piece. In a preferred embodiment, the platform connectors are simple holes or bores with a diameter, H, corresponding to the diameter, A, of the column protrusions 23. In another embodiment, the platform connectors 64 are countersunk holes for cooperation with both the protrusion 23 of a column or end cap, and with the column end or end cap main body. That is, the central bore in the platform is of a diameter, H, substantially the same as, and designed to cooperate with, the protrusion diameter A of a column or diameter F of a top end cap 120. The countersink diameter, J, of countersink 67, on the platform connector mechanism 64 is substantially the same as, and is designed to cooperate with, the cylindrical member diameter of a column or the cap diameter, G, of a top end cap 102.

FIGS. 11-12 illustrate a preferred spacing arrangement of connector mechanisms on base and platform pieces and, coincidently, spacing between adjacent columns. FIG. 11 is of a four-hole platform, while FIG. 12 is of a three-hole platform. Note that while FIGS. 11-12 are of platform pieces 60, the same spacing of connector mechanisms applies to base pieces 70. The arrangement of the connector mechanisms 64 (holes) on the platforms is preferably based on an equilateral triangle design, such that an equilateral triangle is formed by imaginary lines connecting the three holes. The equilateral arrangement of the holes enables platforms to be interchangeable. Also, each platform can be oriented in multiple ways relative to the other platforms in the structure (see FIGS. 5-7 and 13-16).

Additionally, platforms can have four holes, as seen in FIG. 11, arranged to form two adjacent equilateral triangles (FIG. 12). These larger platforms, obviously, still comprise at least three holes forming at least one equilateral triangle. Platforms may have more holes as well, with the same distance between adjacent holes as explained above. Some platforms may have only two holes (FIG. 5-7, 13-16) where the holes are the same distance apart as the holes of the three-hole platforms. Such “two hole” platforms can be used as “bridges” between adjoining portions of the structure. For discussion purposes herein, the distance between the connector holes is referred to as having a “standard distance,” Q, wherein adjacent holes are spaced apart by the standard distance and wherein any three adjacent holes, therefore, form an equilateral triangle when joined by imaginary lines of length Q. FIG. 19 is a top schematic view, shown in overlay, of multiple platforms 60a-c and a base 70 in an exemplary arrangement according to an aspect of the invention.

Bridging platforms can have holes spaced at greater distances than the standard spacing since they do not extend to adjacent columns extending from a common base piece. Where bridging platforms are designed such that each end attaches at a different height above the floor, such as from a shorter column at one end to a longer column at the other end, the hole spacing will also preferably not be of standard length.

Turning to FIGS. 8-10, the exterior surface 22 of a column 10 can be of differing construction, such that some have a surface of exposed plastic, others have a surface of sisal rope or other covering suitable for cat scratching, others are made of wood, etc. The column surfaces can be selected such that, in a structure, multiple surface types are exposed. One version of a column 10 is designed to allow a rope-like material 90 to be wrapped around the column cylindrical member, as shown. The ends 92 of the rope-like material are fastened proximate the ends of the column, without use of adhesive, by trapping the rope ends 92 in an attachment slot 94 defined in the column cylinder and holding the rope ends in place using the end plates 96 of the column. These wrapped columns can be used as cat scratching devices. Further, the design of the column pieces allows the column to be covered with other materials, e.g., sisal rope, carpet or similar material, without the need for adhesive, by capturing these materials between the column shaft and the column end pieces.

Turning to FIGS. 14-16, accessories 98 can be added in multiple locations on the structure 100. Since the platforms 60 and columns 10 are of a modular nature, add-on accessories 98, such as ramps 97, flags, dangling toys 95, etc., have attachment mechanisms, such as a connector with a bore 99 sized to cooperate with a column, and can be attached to the structure in various locations.

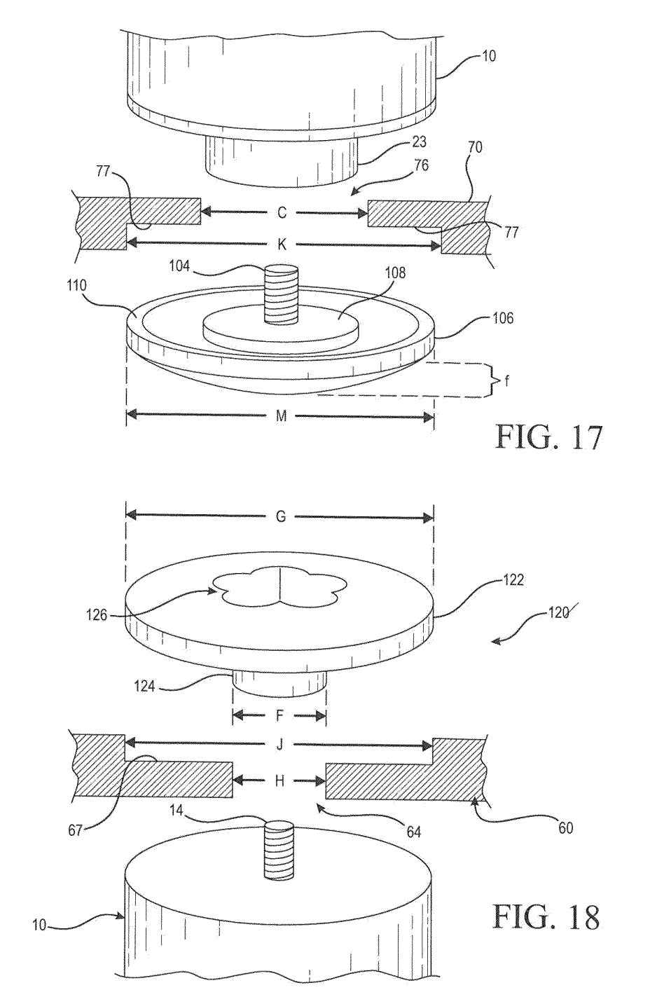

FIG. 17 is a schematic exploded view in partial cross-section of an exemplary bottom end cap 102 for use in connecting the protrusion 23 of a female end 26 a column 10 to a base piece 60. The bottom end cap 102 (or male end cap) has a male threaded connector 104 extending upwardly from a preferably circular bottom end cap body 106. The end cap body 106 defines an upward facing surface 110 which contacts the bottom surface of a base (or platform) or a countersunk surface where such is used. The bottom end cap also can have structural support sections, such as circular central section 108 to stiffen the end cap and to cooperate with an abutting protrusion 23 when assembled. The bottom end cap is shown with an optional projection element 112, here seen as a dome-shape, which projects downward from the end cap body 106. Once assembled, the projection member 112 projects downward from the bottom surface of the base piece a projection height f. Consequently, the end cap projection can be used as a foot for the structure. Where additional feet are used on the base piece, the projection height f should match the height of such feet. In a preferred embodiment, the bottom end cap projection height f is equivalent to other corresponding piece heights, such as a spacer height, for example.

FIG. 18 is a schematic exploded view in partial cross-section of an exemplar top end cap 120 according to an aspect of the invention. The top end cap 120 has a generally cylindrical head 122 with a protrusion 124 extending downwardly therefrom. The protrusion 124 is similar in function and structure to the protrusions discussed herein at the female ends of the columns and so will not be discussed in detail. The protrusion 124 defines a female threaded connection for cooperating connection to a male threaded member 14 at the male end of a column 10 (or of a bottom end cap). The head 122 is preferably of a thickness equivalent to the depth of the countersink 67 on the upper surface of the platform 60 such that, when assembled, the top of the head 122 is flush with the level of the upper surface of the platform. Where a countersink is not used, the top end cap head 122 contacts the upper surface of the platform (or base). The head preferably includes a manipulation mechanism 126, shown as a series of scallop indentations for use with a corresponding wrench. Other manipulation mechanisms can be used, such as single or Phillip's head screw slots, hex-heads, etc., as are known in the art. The head diameter G is preferably substantially equivalent to the countersink diameter J where a countersink is employed. Similarly, the protrusion diameter F is substantially equivalent to the bore diameter H in the platform.

While preferred embodiments of the method and apparatus for forming a pet booster seat have been disclosed, it should be apparent that other and further embodiments may be devised without departing from the basic concepts of the invention. It is to be understood that, while detailed descriptions of a preferred embodiment have been illustrated and described, the invention is not to be limited to the specific arrangement of parts and specific features herein described and illustrated in the drawing. Rather, the descriptions are merely of an exemplary embodiment of the invention, which may be embodied in various forms.

It is claimed:

1. A modular exercise structure for an animal, positionable on a floor surface, the structure comprising:
a. a base piece engageable with the floor surface, the base piece defining at least three connector elements, with adjacent connector elements spaced apart by a standard distance;
b. a plurality of platforms defining a plurality of platform connector elements defined therein, each platform connector element spaced apart a standard distance from adjacent platform connector elements;
c. a plurality of columns, each column having an upper end with an upper end connector member and a lower end with a lower end connector, each column lower end connector connectable to the base piece at a base connector element, each upper column end connector connectable to a lower end connector member of another column, and each upper end connector member and lower end connector member cooperable with a platform connector element; and
d. a plurality of spacers interposable between an upper end connector member of a first column and a lower end connector member of a second column.

2. The structure of claim 1, wherein the plurality of platforms are interchangeable and positionable in multiple orientations.

3. The structure of claim 1, wherein the plurality of columns are interchangeable.

4. The structure of claim 1, wherein the plurality of columns further comprise a plurality of relatively shorter columns and a plurality of relatively taller columns, and wherein the effective height of the taller columns are a factor of the effective height of the shorter columns.

5. The structure of claim 1, wherein the platform defines a platform height and wherein the spacer defines a spacer height, and wherein the spacer and platform heights are equivalent.
